(19) United States
(12) Patent Application Publication
(10) Pub. No.: US 2011/0107878 A1
(43) Pub. Date: May 12, 2011

(54) Tobacco Tin with Bottle Opener

(76) Inventor: William David Gust, Wayzata, MN (US)

(21) Appl. No.: 12/943,113

(22) Filed: Nov. 10, 2010

Related U.S. Application Data
(60) Provisional application No. 61/260,545, filed on Nov. 12, 2009.

(51) Int. Cl. B67B 7/44; B65D 85/00

(52) U.S. Cl. 81/3.15; 206/265

(57) ABSTRACT

A tobacco tin can include a container portion further comprising a main body and a hook member, and a lid further comprising a major portion and an engagement member. The lid is sized to fit over the container portion so that the lid is removably attachable to the container portion. The hook member extends outwardly so that the outermost point of the hook member extends towards the lid and the engagement member extends outwardly so that the outermost point of the engagement member extends towards the container portion when the lid is removably attached to the container portion.

### BACKGROUND

Users of smokeless tobacco have developed a technique for removing the caps of pry-off bottle caps using the lid and container portion of tobacco tins. Though employed by a number of smokeless-tobacco users, this technique is difficult to learn and use.

### SUMMARY

In one aspect, a tobacco tin includes: a container portion including a main body and a hook member; and a lid including a major portion and an engagement member; wherein the hook member extends outwardly towards the lid, and the engagement member extends outwardly towards the container portion.

In another aspect, a tobacco tin includes: a container portion; a lid including a top surface; and a bottle opener embedded in the top surface of the lid.

### DESCRIPTION OF THE DRAWINGS

FIG. 1 is a perspective view of a tobacco tin with bottle opener.

FIG. 2 is another perspective view of a tobacco tin with bottle opener.

FIG. 3 is a top view of a lid of another tobacco tin with bottle opener.

FIG. 4 is another perspective view of a tobacco tin with bottle opener.

FIG. 5 is another perspective view of a tobacco tin with bottle opener.

### DETAILED DESCRIPTION

Example embodiments described herein relate to tobacco tins with bottle openers that can be used to open bottles with pry-off caps, such as beer bottles or soda bottles.

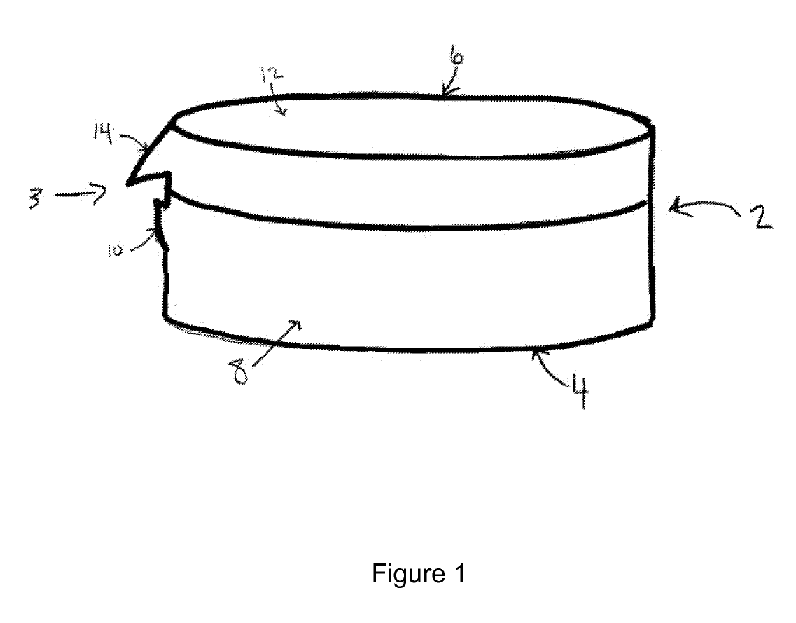

Referring to FIG. 1, an example tobacco tin 2 with an integrated bottle opener 3 is shown.

In one embodiment, the tobacco tin 2 includes a container portion 4 and a lid 6. The lid 6 is sized to fit over the container portion 4 so that the lid 6 is removably attachable to the container portion 4. The lid 6 fits snugly over the container portion 4 to prevent accidental removal of the lid 6. Tobacco or other similar products can be stored within the interior of the tobacco tin 2. The lid 6 can be removed to access the tobacco.

Container portion 4 includes a main body 8 and a hook member 10. The hook member 10 extends outwardly from the main body 8 in such a way that the outermost point of the hook member 10 is extending towards the lid 6 when the lid 6 and the container portion 4 are attached.

In one embodiment, hook member 10 can be used to engage the underside surface of a pry-off bottle cap attached to a bottle. In this way, hook member 10 provides a way to pry such a cap off the bottle, as described further below.

Lid 6 includes a major portion 12 and an engagement member 14. Engagement member 14 extends outwardly from the major portion 12 in such a way that the outermost point of the engagement member 14 is extending towards the container portion 4 when the lid 6 and the container portion 4 are attached.

In one example, lid 6 and main body 8 are keyed so that when lid 6 is coupled to main body 8, the engagement member 14 is positioned over the hook member 10. In another unkeyed example, the user can simply spin lid 6 so that the engagement member 14 is positioned over the hook member 10. In yet another embodiment, the engagement member 14 and/or the hook member 10 are formed all along the peripheries of lid 6 and main body 8. Other configurations are possible.

In one embodiment, engagement member 14 can be used to engage the top surface of a pry-off bottle cap attached to a bottle. In this way, engagement member 14 provides stabilization and pressure onto the bottle cap while the hook member 10 pries off the cap off the bottle.

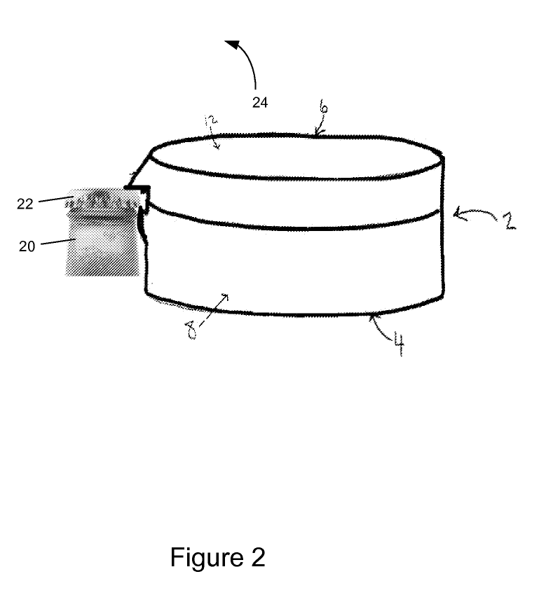

Referring now to FIG. 2, using the tobacco tin 2 described herein, a person can position the tobacco tin 2 in such a way that the hook member 10 engages the underside surface of a pry-off bottle cap attached to the bottle and the engagement member 14 engages the top surface of a bottle cap 22 of a bottle 20. The person using the tobacco tin 2 can then apply force in a direction 24 away from the bottle 20 to pry off the bottle cap 22.

The tobacco tin 2 described above can be any of a variety of sizes so long as the hook member 10 and the engagement member 14 can be used to remove a pry-off bottle cap.

The embodiment described above is just one of many embodiments contemplated. Other variations are also contemplated. For instance, both the hook member 10 and the engagement member 14 may be part of the lid 6 of the tobacco tin 2. Conversely, both the hook member 10 and the engagement member 14 may be part of the container portion 4.

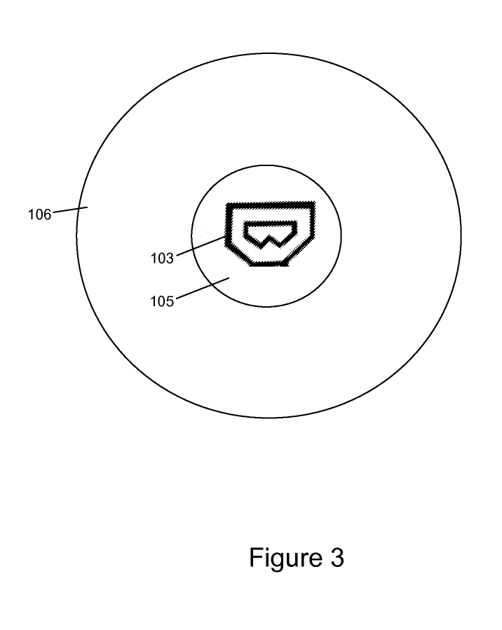

In still further embodiments, a bottle opener may be embedded in the top surface of the lid 6 or the bottom surface of the container portion 4. For example, as shown in FIG. 3, an example lid 106 of a tobacco tin includes a bottle opener 103 embedded therein. In such an example, the opener 103 can be molded into an indention 105 formed in the lid 106. In other examples, the opener 103 can be configured to be removed from the lid 106. Other configurations are possible.

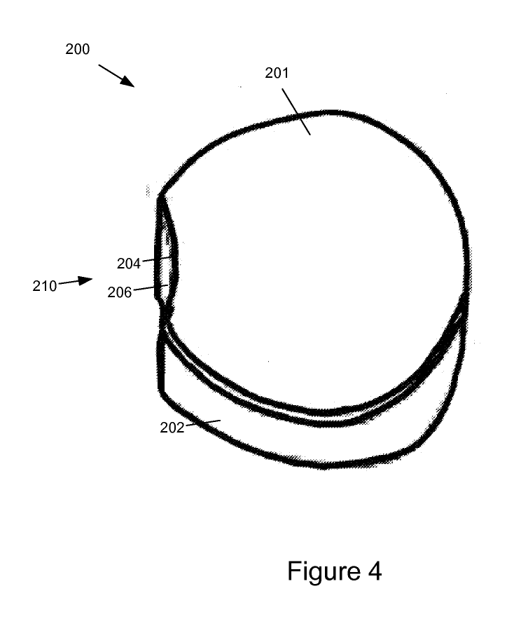

For example, another embodiment of a tobacco tin 200 is shown in FIG. 4. The tin 200 includes a lid 201 and a container portion 202. The lid 201 includes a generally semi-circular indentation 204, and the container portion 202 includes a generally semi-circular indentation 206. When the two indentations are matched rotationally, the indentations 204, 206 together form an indentation 210. The indentation 210 is sized to engage a bottom portion of a bottle cap when placed against a side of a neck of a bottle. The tin can thereupon be moved upwards and/or the bottle moved downwards to remove the bottle cap from the bottle.

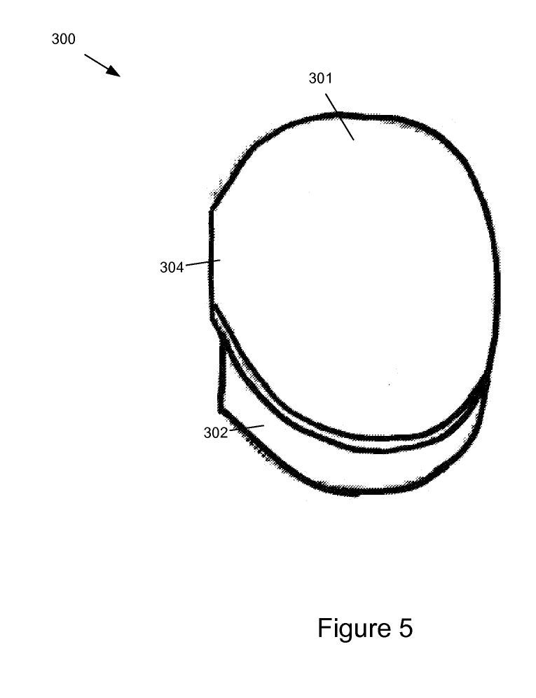

Referring now to FIG. 5, another embodiment of a tobacco tin 300 is shown. The tin 300 includes a lid 301 and a container portion 302. The lid 301 includes a lip 304 that extends from an edge of the lid 301. The lip 304 can be placed under the bottom portion of a bottle cap to remove it in a manner similar to that described above. In some examples, the lip 304 can be contoured or indented in a semi-circular fashion to follow the periphery of the bottle cap. Other configurations are possible.

The various embodiments described above are provided by way of illustration only and should not be construed to be limiting. Various modifications and changes may be made to the embodiments described above without departing from the true spirit and scope of the disclosure.

What is claimed is:

1. A tobacco tin, comprising:
a container portion including a main body and a hook member; and
a lid including a major portion and an engagement member;
wherein the hook member extends outwardly towards the lid, and the engagement member extends outwardly towards the container portion.

2. The tobacco tin of claim 1, wherein the lid is sized to fit over the container portion so that the lid is removably attachable to the container portion.

3. The tobacco tin of claim 2, wherein the lid and the main body are keyed so that when the lid is removably attached to the main body, the engagement member is positioned over the hook member.

4. The tobacco tin of claim 3, wherein the hook member extends along an entire periphery of the main body.

5. The tobacco tin of claim 1, wherein the lid and the main body are keyed so that when the lid is removably attached to the main body, the engagement member is positioned over the hook member.

6. The tobacco tin of claim 1, wherein the hook member extends along an entire periphery of the main body.

7. The tobacco tin of claim 1, wherein the engagement member extends along an entire periphery of the major portion.

8. The tobacco tin of claim 1, wherein the main body is sized to hold chewing tobacco.

9. The tobacco tin of claim 1, further comprising chewing tobacco positioned in the main body.

10. A tobacco tin, comprising:
a container portion;
a lid including a top surface; and
a bottle opener embedded in the top surface of the lid.

11. The tobacco tin of claim 10, wherein the bottle opener is molded into an indentation formed in the top surface of the lid.

12. The tobacco tin of claim 10, wherein the bottle opener is configured to be removed from the lid.

13. The tobacco tin of claim 10, wherein the container portion is sized to hold chewing tobacco.

14. The tobacco tin of claim 10, further comprising chewing tobacco positioned in the container portion.

15. A method of opening a bottle, comprising:
providing a tobacco tin including a container portion having a main body and a hook member, and a lid further comprising a major portion and an engagement member;
providing the bottle with a pry-off bottle cap;
positioning the tobacco tin so that the hook member engages an underside surface of the pry-off bottle cap, and the engagement member engages a top surface of the pry-off bottle cap; and
applying force in a direction away from the bottle to pry off the pry-off bottle cap.

16. The method of claim 15, wherein the hook member extends outwardly so that an outermost point of the hook member extends towards the lid and the engagement member extends outwardly so that the outermost point of the engagement member extends towards the container portion;

17. The method of claim 16, further comprising:
opening the tobacco tin; and
accessing tobacco from within the tobacco tin.

18. The method of claim 17, further comprising removing the lid from the container portion.

19. The method of claim 15, further comprising:
opening the tobacco tin; and
accessing tobacco from within the tobacco tin.

20. The method of claim 19, further comprising removing the lid from the container portion.
